(19) United States
(12) Patent Application Publication
(10) Pub. No.: US 2009/0058777 A1
(43) Pub. Date: Mar. 5, 2009

(54) Liquid crystal display device and method for driving same

(75) Inventor: Yung-Chiang Cheng, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/229,845

(22) Filed: Aug. 26, 2008

(30) Foreign Application Priority Data
Aug. 31, 2007 (CN) 200710076769.1

(51) Int. Cl. G09G 3/36

(52) U.S. Cl. 345/88

(57) ABSTRACT

An exemplary liquid crystal display device includes pixel units. Each pixel unit includes a first sub pixel unit and a second sub pixel unit. The first sub pixel unit is associated with one of three primary colors, and the second sub pixel unit is associated with one of three complementary colors of the three primary colors. An exemplary method for driving the liquid crystal display device is also provided.

### FIELD OF THE INVENTION

The present disclosure relates to a liquid crystal display (LCD) device and a method for driving the LCD device.

### BACKGROUND

LCD devices are commonly used as displays for compact electronic apparatuses, because they provide good quality images with little power consumption and are very thin. The LCD device includes a liquid crystal panel having a thin film transistor (TFT) substrate, a color filter substrate, and a liquid crystal layer interposed between the two substrates. Since the liquid crystal material in the LCD device does not emit light, a backlight module for supplying light should be disposed adjacent to a rear surface of the liquid crystal panel. Transmittance of the light emitted from the backlight module is adjusted according to an arrangement state of liquid crystal molecules controlled by an electric field. Thus, the LCD device can display images such as texts and pictures.

Usually, display characteristics of the LCD device are defined by viewing angle, capability of displaying a moving image, color reproducibility, etc. The LCD device conventionally uses three primary colors of red, green, and blue to display color images. However, when only three primary colors of red, green, and blue are used to display the images, there are drawbacks in that color expression for complementary colors of the three primary colors and color reproducibility are limited.

Therefore, an improved LCD device is desired to overcome the above-described deficiencies.

### SUMMARY

An aspect of the invention relates to an LCD device including a plurality of pixel units. Each pixel unit includes a first sub pixel unit and a second sub pixel unit. The first sub pixel unit is associated with one of three primary colors, and the second sub pixel unit is associated with one of three complementary colors of the three primary colors.

Other novel features and advantages will become more apparent from the following detailed description and when taken in conjunction with the accompanying drawings.

### BRIEF DESCRIPTION OF THE DRAWINGS

The components in the drawings are not necessarily drawn to scale, the emphasis instead placed upon clearly illustrating the principles of at least one embodiment. In the drawings, like reference numerals designate corresponding parts throughout the various views.

FIG. 1 is a block diagram of a first embodiment of an LCD device, the LCD device including a plurality of pixel units.

FIG. 2 is an enlarged block diagram of one embodiment of a pixel unit of FIG. 1.

FIG. 3 is a block diagram of a second embodiment of an LCD device, the LCD device including a plurality of pixel units.

FIG. 4 is an enlarged block diagram of one embodiment of a pixel unit of FIG. 3.

### DETAILED DESCRIPTION

Reference will now be made to the drawings to describe the embodiments in detail.

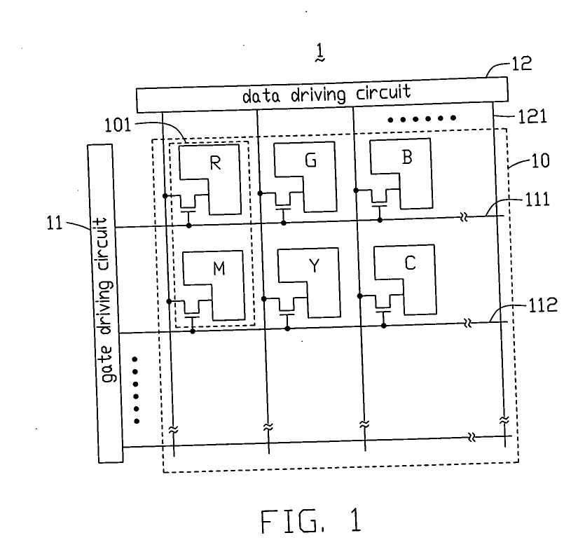

Referring to FIG. 1, a first embodiment of an LCD device 1 includes a TFT substrate 10, a gate driving circuit 11, a data driving circuit 12, and a plurality of pixel units 101. The TFT substrate 10 includes a plurality of first gate lines 111, a plurality of second gate lines 112, and a plurality of data lines 121. The first gate lines 111 and the second gate lines 112 are connected to the gate driving circuit 11, and are arranged alternately and parallel to each other. The gate driving circuit 11 provides gate signals to the first gate lines 111 and the second gate lines 112. The data lines 121 are connected to the data driving circuit 12, and are perpendicular to the first and second gate lines 111, 112. The data driving circuit 12 provides data signals to the data lines 121.

The LCD device 1 further includes a color filter substrate (not shown) opposite to the TFT substrate 10, and a liquid crystal layer (not shown) interposed between the two substrates. The color filter substrate includes a color filter. The color filter includes a plurality of three primary color filter units of red, green, and blue, and a plurality of three complementary color filter units of magenta, yellow, and cyan. It may be understood that the colors of the three complementary color filter units are not limited to magenta, yellow, and cyan. In an alternative embodiment, the color filter can be disposed on the TFT substrate 10. It may be understood that the three primary colors and the three complementary colors correspond to various color wavelengths in the visible light spectrum.

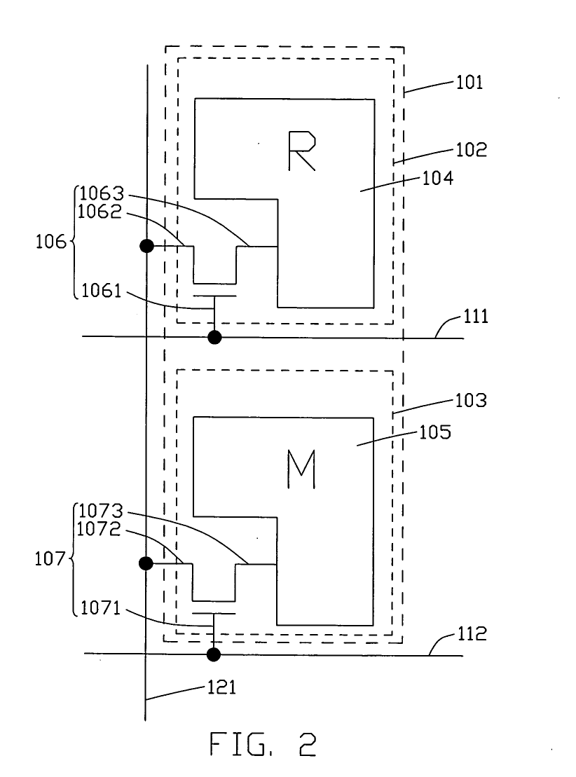

Referring also to FIG. 2, one of the pixel units 101 includes a first sub pixel unit 102 and a second sub pixel unit 103. The first sub pixel unit 102 corresponds to one of the three primary color filter units of red, green, and blue or one of the three complementary color filter units of magenta, yellow, and cyan. The second sub pixel unit 103 corresponds to one of the three complementary color filter units of magenta, yellow, and cyan or one of the three primary color filter units of red, green, and blue. In the illustrated embodiment, the first sub pixel unit 102 corresponds to a red color filter unit, and the second sub pixel unit 103 corresponds to a magenta color filter unit. Adjacent pixel units 101 correspond to a different primary color filter unit and a complementary color filter unit. The first sub pixel unit 102 includes a first pixel electrode 104 and a first TFT 106. The first TFT 106 includes a gate electrode 1061, a source electrode 1062, and a drain electrode 1063. The gate electrode 1061 is connected to a corresponding first gate line 111, the source electrode 1062 is connected to a corresponding data line 121, and the drain electrode 1063 is connected to the first pixel electrode 104. The second sub pixel unit 103 includes a second pixel electrode 105 and a second TFT 107. The second TFT 107 includes a gate electrode 1071, a source electrode 1072, and a drain electrode 1073. The gate electrode 1071 is connected to a corresponding second gate line 112, the source electrode 1072 is connected to the data line 121 the source electrode 1062 of the first TFT 106 is connected to, and the drain electrode 1073 is connected to the second pixel electrode 105.

When the LCD device 1 displays images, the gate driving circuit 11 provides gate-on signals to the first and second gate lines 111, 112, and the data driving circuit 12 provides data signals to the data lines 121. The images correspond to displaying various frames n on a display of the LCD device. It maybe understood that n is a natural number. In frame n−1, where n≧2, the first gate line 111 is turned on and the data driving circuit 12 provides image data signals to the first sub pixel units 102. When the second gate line 112 is turned on, the data driving circuit 12 provides monochromatic data signals to the second sub pixel units 103, where the monochromatic data signals maybe black or gray data signals. In frame n, when the first gate line 111 is turned on, the data driving circuit 12 provides monochromatic data signals to the first sub pixel units 102. When the second gate line 112 is turned on, the data driving circuit 12 provides image data signals to the second sub pixel units 103. In frame n+1, the situation in frame n−1 is repeated. In frame n+2, the situation in frame n is repeated. Thus, frame n−1 and frame n define a minimum period. In frame n+1 and the following frames, the same sequence and situation of the minimum period are repeated, and the first sub pixel units 102 and the second sub pixel units 103 respectively display the corresponding image data signals and the monochromatic data signals alternately in every two adjacent frames.

The data driving circuit 12 provides image data signals at an updating frequency of 120 Hz, and provides same image data signals to the first sub pixel units 102 and the second sub pixel units 103 for every two adjacent frames.

Because the LCD device 1 uses the first sub pixel units 102 corresponding to the three primary color filter units of red, green, and blue, and the second sub pixel units 103 corresponding to the three complementary color filter units of magenta, yellow, and cyan to display color images, or vice versa, more of a variety of colors can be displayed as compared with only using the conventional colors red, green, and blue. Thus, color expression and color reproducibility of the LCD device 1 are improved. Furthermore, the LCD device 1 uses the first sub pixel units 102 and the second sub pixel units 103 respectively to display the corresponding image data signals and the monochromatic data signals alternately in every two adjacent frames. This driving method reduces a holding time of the image data signals. Thus, flickering phenomenon and after or residual image phenomenon when displaying a moving image can be reduced or substantially eliminated.

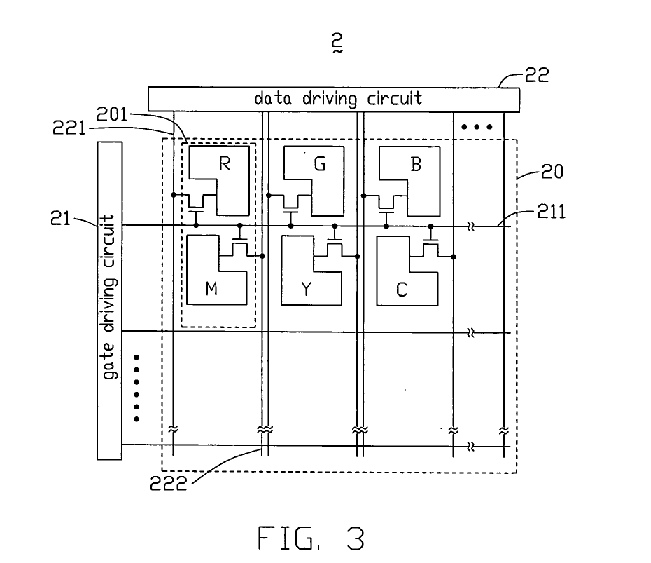

Referring to FIG. 3, a second embodiment of an LCD device 2 includes a TFT substrate 20, a gate driving circuit 21, a data driving circuit 22, and a plurality of pixel units 201. The TFT substrate 20 includes a plurality of gate lines 211, a plurality of first data lines 221, and a plurality of second data lines 222. The first data lines 221 and the second data lines 222 are connected to the data driving circuit 22, and are arranged alternately and parallel to each other. The data driving circuit 22 provides data signals to the first data lines 221 and the second data lines 222. The gate lines 211 are connected to the gate driving circuit 21, and are perpendicular to the first and second data lines 221, 222. The gate driving circuit 21 provides gate signals to the gate lines 211.

The LCD device 2 further includes a color filter substrate (not shown) opposite to the TFT substrate 20, and a liquid crystal layer (not shown) interposed between the two substrates. The color filter substrate includes a color filter. The color filter includes a plurality of three primary color filter units of red, green, and blue, and a plurality of three complementary color filter units of magenta, yellow, and cyan. It may be understood that the colors of the three complementary color filter units are not limited to magenta, yellow, and cyan. In an alternative embodiment, the color filter can be disposed on the TFT substrate 10.

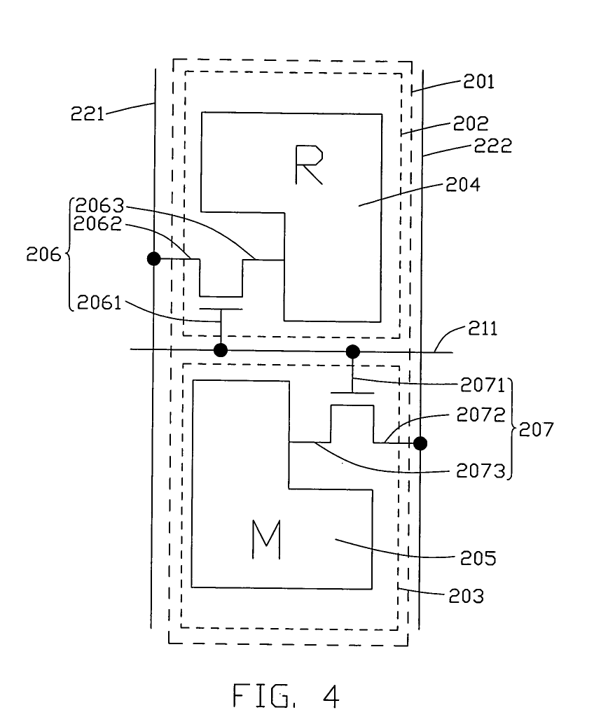

Referring also to FIG. 4, one of the pixel units 201 includes a first sub pixel unit 202 and a second sub pixel unit 203. The first sub pixel unit 202 corresponds to one of the three primary color filter units of red, green, and blue or one of the three complementary color filter units of magenta, yellow, and cyan, and the second sub pixel unit 203 corresponds to one of the three complementary color filter units of magenta, yellow, and cyan or one of the three primary color filter units of red, green, and blue. In the illustrated embodiment, the first sub pixel unit 202 corresponds to a red color filter unit, and the second sub pixel unit 203 corresponds to a magenta color filter unit. Adjacent pixel units 201 correspond to different primary color filter unit and complementary color filter unit. The first sub pixel unit 202 includes a first pixel electrode 204 and a first TFT 206. The first TFT 206 includes a gate electrode 2061, a source electrode 2062, and a drain electrode 2063. The gate electrode 2061 is connected to a corresponding gate line 211, the source electrode 2062 is connected to a corresponding first data line 221, and the drain electrode 2063 is connected to the first pixel electrode 204. The second sub pixel unit 203 includes a second pixel electrode 205 and a second TFT 207. The second TFT 207 includes a gate electrode 2071, a source electrode 2072, and a drain electrode 2073. The gate electrode 2071 is connected to the gate line 211 the gate electrode 2061 of the first TFT 206 is connected to, the source electrode 2072 is connected to a corresponding second data line 222, and the drain electrode 2073 is connected to the second pixel electrode 205.

When the LCD device 2 displays images, in frame n−1 (n≧2), the gate driving circuit 21 provides gate-on signals to the gate lines 211, and the data driving circuit 22 provides image data signals to the first data lines 221 and monochromatic data signals to the second data lines 222. The monochromatic data signals maybe black or gray data signals. Thus, the first sub pixel units 202 display image data signals, and the second sub pixel units 203 display monochromatic data signals. In frame n, the gate driving circuit 21 provides gate-on signals to the gate lines 211, and the data driving circuit 22 provides image data signals to the second data lines 222 and monochromatic data signals to the first data lines 221. The monochromatic data signals maybe black or gray data signals. Thus, the first sub pixel units 202 display monochromatic data signals, and the second sub pixel units 203 display image data signals. In frame n+l, the situation in frame n−1 is repeated. In frame n+2, the situation in frame n is repeated. Thus, frame n−1 and frame n define a minimum period. In frame n+1 and the following frames, the same sequence and situation of the minimum period are repeated, and the first sub pixel units 202 and the second sub pixel units 203 respectively display the corresponding image data signals and the monochromatic data signals alternately in every two adjacent frames.

The data driving circuit 22 provides image data signals at an updating frequency of 120 Hz, and provides same image data signals to the first sub pixel units 202 and the second sub pixel units 203 in every two adjacent frames.

Because the LCD device 2 uses the first sub pixel units 202 corresponding to the three primary color filter units of red, green, and blue, and the second sub pixel units 203 corresponding to the three complementary color filter units of magenta, yellow, and cyan to display color images, or vice versa, more of a variety of colors can be displayed as compared with only using the conventional colors red, green, and blue. Thus, color expression and color reproducibility of the LCD device 2 are improved. Furthermore, the LCD device 2 uses the first sub pixel units 202 and the second sub pixel units 203 respectively to display the corresponding image data signals and the monochromatic data signals alternately in every two adjacent frames, this driving method reduces a holding time of the image data signals. Thus, flickering phenomenon and after or residual image phenomenon when displaying a moving image can be reduced or substantially eliminated.

It is to be understood that even though numerous characteristics and advantages of the present embodiments have been set forth in the foregoing description with details of the structures and functions of the embodiments, the disclosure is illustrative only, and changes made in detail, especially in matters of shape, size, and arrangement of parts, within the principles of the embodiments, to the full extent indicated by the broad general meaning of the terms in which the appended claims are expressed.

What is claimed is:

1. A liquid crystal display device, comprising:
a plurality of pixel units;
wherein each pixel unit comprises a first sub pixel unit and a second sub pixel unit, the first sub pixel unit associated with one of three primary colors, and the second sub pixel unit associated with one of three complementary colors of the three primary colors.

2. The liquid crystal display device of claim 1, wherein the first sub pixel unit is associated with one of three primary colors of red, green, and blue.

3. The liquid crystal display device of claim 2, wherein the second sub pixel unit is associated with one of three complementary colors of magenta, yellow, and cyan.

4. The liquid crystal display device of claim 3, further comprising a thin film transistor substrate, wherein the thin film transistor substrate comprises a gate driving circuit and a data driving circuit, the gate driving circuit configured for providing gate signals to the pixel units, and the data driving circuit configured for providing data signals to the pixel units.

5. The liquid crystal display device of claim 4, wherein the thin film transistor substrate further comprises a plurality of first gate lines, a plurality of second gate lines, and a plurality of data lines, the first and second gate lines connected to the gate driving circuit, and arranged alternately and parallel to each other, the data lines connected to the data driving circuit, and perpendicular to the first and second gate lines.

6. The liquid crystal display device of claim 5, wherein the first sub pixel unit comprises a first pixel electrode and a first thin film transistor, and the second sub pixel unit comprises a second pixel electrode and a second thin film transistor, the first thin film transistor comprising a gate electrode, a source electrode, and a drain electrode, the gate electrode connected to a corresponding first gate line, the source electrode connected to a corresponding data line, and the drain electrode connected to the first pixel electrode; the second thin film transistor comprising a gate electrode, a source electrode, and a drain electrode, the gate electrode connected to a corresponding second gate line, the source electrode connected to the data line the source electrode of the first thin film transistor is connected to, and the drain electrode connected to the second pixel electrode.

7. The liquid crystal display device of claim 4, wherein the thin film transistor substrate further comprises a plurality of gate lines, a plurality of first data lines, and a plurality of second data lines, the first and second data lines connected to the data driving circuit, and arranged alternately and parallel to each other, the gate lines connected to the gate driving circuit, and perpendicular to the first and second data lines.

8. The liquid crystal display device of claim 7, wherein the first sub pixel unit comprises a first pixel electrode and a first thin film transistor, and the second sub pixel unit comprises a second pixel electrode and a second thin film transistor, the first thin film transistor comprising a gate electrode, a source electrode, and a drain electrode, the gate electrode connected to a corresponding gate line, the source electrode connected to a corresponding first data line, and the drain electrode connected to the first pixel electrode; the second thin film transistor comprising a gate electrode, a source electrode, and a drain electrode, the gate electrode connected to the gate line the gate electrode of the first thin film transistor is connected to, the source electrode connected to a corresponding second data line, and the drain electrode connected to the second pixel electrode.

9. A method for driving a liquid crystal display device, comprising:
(a) providing a plurality of pixel units;
wherein each pixel unit comprises a first sub pixel unit and a second sub pixel unit, the first sub pixel unit associated with one of three primary colors, and the second sub pixel unit associated with one of three complementary colors of the three primary colors;
(b) displaying monochromatic data signals in a frame n−1 via the second sub pixel units, and displaying corresponding image data signals via the first sub pixel units, wherein n≧2;
(c) displaying monochromatic data signals in a frame n via the first sub pixel units, and displaying corresponding image data signals via the second sub pixel units;
repeating (b)-(c) for n+1 and greater frames.

10. The method of claim 9, wherein the first sub pixel unit is associated with one of three primary colors of red, green, and blue.

11. The method of claim 10, wherein the second sub pixel unit is associated with one of three complementary colors of magenta, yellow, and cyan.

12. The method of claim 11, wherein the liquid crystal display device further comprises a thin film transistor substrate, the thin film transistor substrate comprising a gate driving circuit and a data driving circuit, the gate driving circuit configured for providing gate signals to the pixel units, and the data driving circuit configured for providing data signals to the pixel units.

13. The method of claim 12, wherein the thin film transistor substrate further comprises a plurality of first gate lines, a plurality of second gate lines, and a plurality of data lines, the first and second gate lines connected to the gate driving circuit, and arranged alternately and parallel to each other, the data lines connected to the data driving circuit, and perpendicular to the first and second gate lines.

14. The method of claim 13, wherein the gate driving circuit provides gate-on signals to the first and second gate lines, and the data driving circuit provides data signals to the data lines; in frame n−1, when the first gate line is turned on, the data driving circuit provides image data signals to the first sub pixel units, and when the second gate line is turned on, the data driving circuit provides monochromatic data signals to the second sub pixel units; in frame n, when the first gate line is turned on, the data driving circuit provides monochromatic data signals to the first sub pixel units, and when the second gate line is turned on, the data driving circuit provides image data signals to the second sub pixel units.

15. The method of claim 12, wherein the thin film transistor substrate further comprises a plurality of gate lines, a plurality of first data lines, and a plurality of second data lines, the first and second data lines connected to the data driving circuit, and arranged alternately and parallel to each other, the gate lines connected to the gate driving circuit, and perpendicular to the first and second data lines.

16. The method of claim 15, wherein in frame n−1, the gate driving circuit provides gate-on signals to the gate lines, and the data driving circuit provides image data signals to the first data lines and monochromatic data signals to the second data lines; in frame n, the gate driving circuit provides gate-on signals to the gate lines, and the data driving circuit provides image data signals to the second data lines and monochromatic data signals to the first data lines.

17. The method of claim 9, wherein the monochromatic data signals are black data signals.

18. The method of claim 9, wherein the monochromatic data signals are gray data signals.
